(19) United States
(12) Patent Application Publication
(10) Pub. No.: US 2024/0075647 A1
(43) Pub. Date: Mar. 7, 2024

(54) SLICING MACHINE WITH TRANSVERSELY MODULAR SUPPORT FRAME AND CONSTRUCTION KIT FOR ITS CREATION

(71) Applicant: MULTIVAC SEPP HAGGENMUELLER SE & CO. KG, Wolfertschwenden (DE)

(72) Inventor: Tom STACHEL, Kempten (DE)

(73) Assignee: MULTIVAC SEPP HAGGENMUELLER SE & CO. KG, Wolfertschwenden (DE)

(21) Appl. No.: 18/236,962

(22) Filed: Aug. 23, 2023

(30) Foreign Application Priority Data
Sep. 7, 2022 (DE) 102022122661.1

(51) Int. Cl. B26D 7/32; B26D 7/06

(52) U.S. Cl. CPC B26D 7/32; B26D 7/0625; B26D 2007/0012

(57) ABSTRACT

In order to be able to manufacture differently designed support frames, often of different lengths but also of different widths, for different slicer designs with lower bearing and logistics costs, they are assembled from—differently designable—lateral support modules on the one hand and transverse support modules of different lengths on the other, but the transverse support modules are only detachably connected to the lateral support modules, usually by bolting. These modules in turn can be composed of submodules, which in turn can be composed of individual elements, whereby connection to the entire modules can also be made by welding.

### CROSS-REFERENCE TO RELATED APPLICATIONS

This application claims priority to German Patent Application No. DE 102022122661.1 filed on Sep. 7, 2022, the disclosure of which is incorporated in its entirety by reference herein.

### TECHNICAL FIELD

The invention relates to slicing machines, in particular so-called slicers, which are used in the food industry to slice strands or sticks of a product such as sausage or cheese.

### BACKGROUND

Since these strands or sticks can be produced with a cross section that retains its shape and dimensions well over its length, i.e. essentially constant, they are called product calibers, or calibers for short.

In this process, product calibers arranged parallel to each other on several tracks are sliced simultaneously by a cutting unit by cutting off one slice at a time from the same blade, which moves in transverse direction to the longitudinal direction of the calibers.

The calibers are pushed forward by a supply conveyor of a cutting unit in the direction of the blade of the cutting unit, usually on an obliquely downwardly directed supply conveyor, and are each guided through the product openings of a plate-shaped so-called cutting frame, at the front end of which the part of the caliber projecting beyond it is cut off as a slice by the blade directly in front of the cutting frame.

The slices generally fall onto a discharge conveyor of a discharge unit, by means of which they are transported away for further processing.

During slicing, the product calibers are usually held at their rear end facing away from the cutting frame by a gripper, which is provided with corresponding gripper claws for this purpose.

For reloading the slicer with new product calibers, the supply unit can usually be folded down from the inclined slicing position to a horizontal loading position for easier loading.

This can be done while the rest of the calibers are still being finished—held by the grippers and/or an existing upper and lower driven product guide.

After this has been done, the end piece that can no longer be sliced is removed by the grippers, which move away from the cutting unit to their initial position at a maximum distance therefrom, so that when the supply conveyor is subsequently pivoted upwards, the grippers are again behind the rear ends of the new product calibers and can grip them.

All these functional units are attached, usually bolted, to a support frame of the machine.

Such slicing machines, especially slicers, are usually offered by the manufacturer in different sizes and configurations, which can differ in terms of
the number of their tracks,
accordingly, the width of their cutting unit, in particular its drive power and the flying circle of their blade,
the width of the supply unit and/or discharge conveyor, and in the case of track-specific units, the number of conveyors of these units side by side in the transverse direction,
the number and/or length of the discharge conveyors of the discharge unit,
the length of the supply unit depending on the maximum length of the calibers to be cut, etc.

Accordingly, the manufacturer of the machines has to provide a large number of differently dimensioned and, if necessary, differently shaped support frames, the support struts of which are usually welded together for stability reasons.

In this context, it is already known, for example from DE 10 2013 207 744 A1, to assemble the support frame from several support frame modules which adjoin or overlap one another in the longitudinal direction.

### SUMMARY

It is therefore the object of the invention to provide a slicing machine, in particular a slicer, which is of modular design such that the slicing machine can be created quickly and easily in different configurations and dimensions, in particular in the transverse direction, and to provide a construction kit for this purpose.

A generic slicing machine, in particular a slicer, for slicing calibers and producing portions from these slices usually comprises:
a support frame with two lateral support modules and at least one transverse support module extending therebetween in transverse direction, the major directions of extension of the lateral support modules being in or parallel to the vertical longitudinal plane defined by the vertical and the passage direction of the products through the machine,
on said support frame there are detachably fastened cladding elements and detachably fastened protection elements, the cladding elements also being intended to prevent interference with the machine during operation like the protection elements, but the cladding elements being generally immovably fastened to the support frame, while protection elements are understood to be those which are fastened movably relative to the support frame, such as protective doors or protective hoods,
functional units are detachably fastened to this support frame, in particular
   a cutting unit with a, for example rotating, blade,
   a supply unit for supplying at least one caliber to the cutting unit,
   a discharge unit with at least one portioning belt for transporting away the slices or portions produced therefrom.

The support frame can comprise beam-shaped support struts or plate-shaped support plates as elements, beam-shaped support struts preferably being used as profiles, generally as steel profiles, with a mostly circumferentially closed hollow cross section.

According to the invention, the one or more transverse support modules extending between the lateral support modules are detachably fastened, in particular bolted, to the lateral support modules. By using transverse support modules of different lengths, the transverse spacing of the lateral support modules can be varied and support frames for slicing machines of different widths—hereinafter referred to only as slicers, without limiting the slicing machines thereto—can thus be created, in particular for slicers with different numbers of tracks and/or tracks of different widths.

This reduces the costs for warehousing and logistics for the individual parts of the support frame.

Furthermore, the support frame is subdivided into support frame modules, in which the lateral support modules and transverse support modules are subdivided into modules, namely the lateral support modules comprise a plurality of lateral support submodules and the transverse support modules comprise a plurality of transverse support submodules, which are also preferably detachably connected to one another, in particular screwed together.

This further subdivides the modular structure of the support frame and makes it even easier to create differently designed support frames.

The support frame modules, in particular the lateral support submodules, are located at different longitudinal positions within the support frame, i.e. they have different areas of extension in the longitudinal direction—the general passage direction of the products through the machine—which can also overlap but are usually not identical.

The lateral support submodules can be detachably fastened to each other directly at a connection point and/or indirectly via transverse supports by attaching a transverse support at one end to such a connection point of the lateral support submodules, which is simultaneously connected to both lateral support submodules at this end.

This can additionally improve the stability of the, e.g. bolted, support frame.

Also, the individual, e.g. lateral, support submodules do not have to be formed in one piece, but can in particular comprise several detachably interconnected lateral support elements as module elements, in particular beam-shaped lateral support elements, such as steel profiles.

Preferably, in the assembled state, these beam-shaped module elements, in particular steel sections, have a largest extension direction in the vertical or horizontal, in particular the horizontal passage direction.

This makes it possible in particular to create approximately cuboid support frames in which beam-shaped module elements, such as steel sections, form vertically positioned support posts in the corners and longitudinal crossbars and transverse crossbars running in the longitudinal and transverse directions at the bottom, with feet, preferably height-adjustable feet, being arranged in particular on the longitudinal crossbars.

The lateral support submodules do not necessarily have to be kept at a distance from one another by means of transverse supports arranged directly between them—the lateral support submodules generally running with their main planes parallel to one another—but the lateral support submodules of one support frame module can be kept at a distance in the transverse direction by the other support frame module attached to it, in particular the transverse supports thereof.

The other parts attached to the support frame can also be subdivided in additional modules:

The cladding elements fixedly fastened to the support frame and/or the protection elements movably fastened to the support frame can have several adjoining cladding elements, in particular protection elements, in a direction lying in their main plane, in particular in the longitudinal direction, the vertical direction and/or the transverse direction, in particular detachably connected to one another.

This applies in particular to the plate-shaped cladding elements extending vertically and in the transverse direction.

If cladding elements serve as protection elements, their functionality and stability must be verified by conformity tests, e.g. in accordance with DIN-EN 16743 “Food processing machines—Automatic cutting machines for industrial use—Safety and hygiene requirements”.

By assembling the protective parts from individual protective elements, this proof can be provided once for the individual protective element, and from this—fixed or movable—protective parts can be created for different sized machine types of an entire series, without having to carry out the conformity tests for the different sized protective parts of each individual machine type.

The functional parts of the functional units extending in transverse direction, in particular the belt conveyors or belt conveyors of the supply unit and/or the discharge unit, can also have individual functional elements adjoining one another in transverse direction, detachably connected to one another and running next to one another, in particular conveyor belts and/or deflection drums for the conveyor belts and/or axles for the deflection drums.

Due to the modular nature of the slicer, in particular its support frame, by detachably connecting individual modules or elements, a construction kit can be created with these modules or elements from construction kit parts, so that from only a relatively small number of different construction kit parts, in particular different types of the functionally same construction kit part, a very large number of variants of differently designed, in particular differently dimensioned, slicers and their support frames can be created.

With regard to such a construction kit for creating a slicer, which is used for slicing calibers into slices and creating portions from slices, and which comprises a support frame with two lateral support modules and transverse support modules therebetween, in particular a slicing machine, in particular a slicer, as described above, this object is achieved in that the construction kit comprises as construction kit parts
at least one type of lateral support module each, and
several types of differently dimensioned transverse support modules, in particular transverse support modules of different lengths.

This already makes it easy to produce support frames of different widths that can be used for slicers with different numbers of tracks and/or tracks of different widths.

The construction kit parts preferably each comprise at least one fixing device, which may be one or more simple fixing holes for inserting screws and/or a fixing flange for attachment to another construction kit part and detachable connection, in particular screwing, to these other modular parts, if necessary again by means of fixing holes in this fixing flange.

Preferably, these fixing devices are attached to the same positions on the construction kit parts serving the same purpose.

In the case of a left and a right lateral support module, this can mean that the fixing device, for example a hole pattern of fixing holes, is arranged in the same position in the side view, but in the case of a lateral support module having a hollow profile, it is arranged in each case on the inner side facing the other lateral support module.

In the case of construction kit parts running from bottom to top, such as a vertical brace of or for a lateral support module or a transverse brace of or for a transverse support module, the types of which differ in length, the same position means, for example, that the fixing device is always arranged in the end section of the brace, in particular always at the same distance from the free end.

In the case of a construction kit part in which a fixing device is present not only in the end sections but also in the middle section, analogous position can mean that despite the different lengths of the various types of this construction kit part, this middle fixing device is always arranged at the same distance from one of the two ends of the construction kit part.

If the lateral supports consist of several lateral support submodules, the object is achieved in that at least one type, preferably several types, of each of these different lateral support submodules are present as construction kit parts.

This greatly increases the variability of the construction kit and the different slicers that can be manufactured from it.

Preferably, connecting elements are also provided as construction kit parts for detachable connection of the other construction kit parts to each other, in particular of the lateral support modules to the transverse support modules.

Such connecting elements can be rigid connecting elements, such as screws, or connecting elements that are movable in themselves in the permanently assembled state, for example hinges, with which, for example, a safety door can be detachably fastened to a part of the support frame.

Preferably, both rigid and movable connecting elements are available as construction kit parts, in particular not only in one, but in several types with regard to function and/or dimensions.

In general, in the case of different types of a construction kit part, the construction kit parts of the different types can differ in that they have, for example, qualitatively the same overall shape, i.e. in the assembled state in the side view they are shaped, for example, straight or angled, but quantitatively, despite approximately the same overall shape, the construction kit parts of the different types have different dimensions, be it a different maximum greatest length and/or different thickness or wall thickness.

The reverse case is also possible, in that in the case of different types of the functionally same construction kit part, the construction kit parts of the different types have qualitatively different overall shapes, for example angled or curved in one case, and straight in the other case, but quantitatively these construction kit parts have the same main dimensions, for example the same length, so that in particular the fastening devices are arranged in corresponding, i.e. analogous, positions, for example in the end section of the construction kit parts of these different types.

In the case of construction kit parts which enclose a metal profile, in particular a steel profile, the different types of this construction kit part can also differ from one another only by the wall thickness and/or by a profile cross section of different size.

This may be necessary for the stability of the different slicers to be manufactured therefrom.

Furthermore, base frames for conveyor belt units can also be present as construction kit parts, in particular in several types, in particular base frames of different widths for conveyor belt units of different widths, for example for accommodating several individual conveyor belts in the base frame next to each other in different numbers.

### BRIEF DESCRIPTION OF THE DRAWINGS

Embodiments according to the invention are described in more detail below by way of example and with reference to the following drawings, which show:

FIGS. 1a, b: a slicing machine in the form of a slicer according to the prior art in different perspective views, with the supply belt folded up into the slicing position,

FIG. 2a: a simplified side view of the slicing machine, free of cladding elements, so that the individual conveyor belts can be seen more clearly, loaded with a caliber of product,

FIG. 2b: a side view as shown in FIG. 2a, but with the supply belt folded down into the loading position and the product caliber sliced except for a caliber end piece,

FIG. 2c: a side view with the supply belt folded down into the loading position as in FIG. 2b, but with the support frame and some cladding elements and the operating unit depicted,

FIGS. 3a, 3b: a finished support frame in two different forms, assembled from lateral support modules in the side view,

FIG. 4: top view of the support frame shown in FIG. 3b,

FIG. 5a: the area of the discharge conveyor unit of the multi-track slicer in top view,

FIG. 5b: a sectional view through several aligned deflection drums of the multi-track discharge conveyor unit.

### DETAILED DESCRIPTION

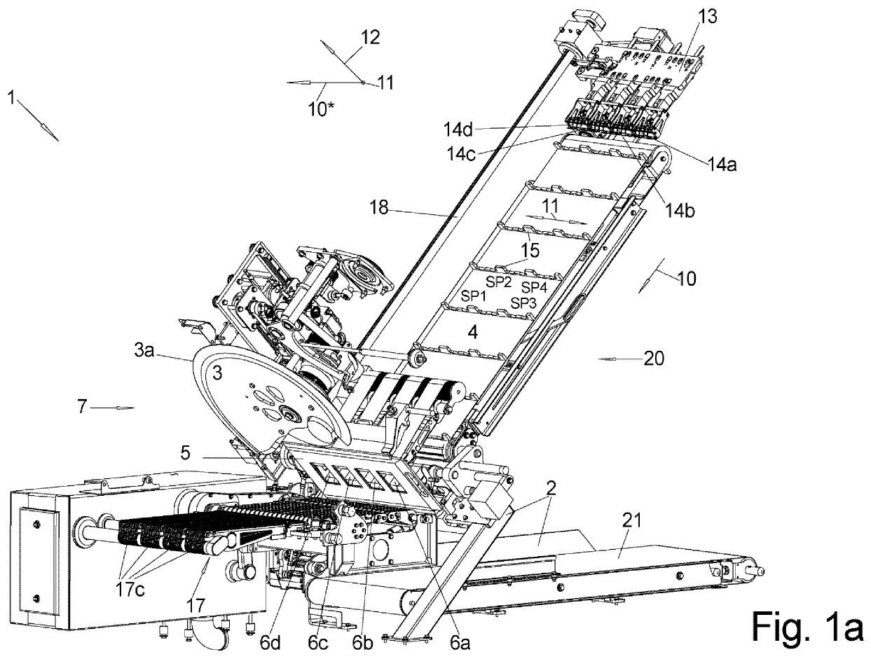

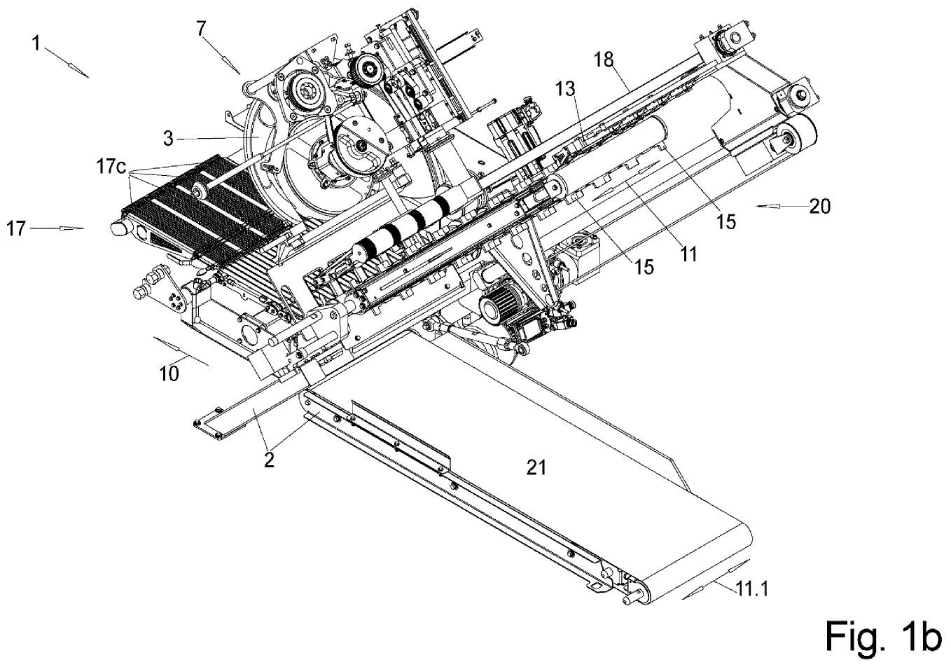

FIGS. 1a, 1b show different perspective views of a multi-track slicer 1 for simultaneous slicing of several product calibers K each on one track SP1 to SP4 next to each other and depositing in shingled portions P of several slices S with a general passage direction 10* through the slicer 1 from right to left.

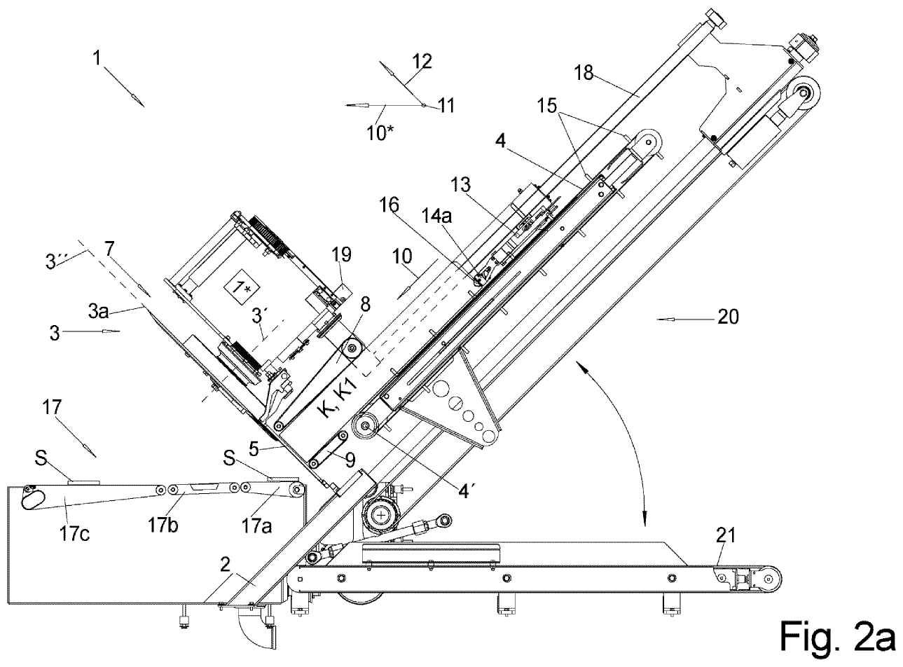

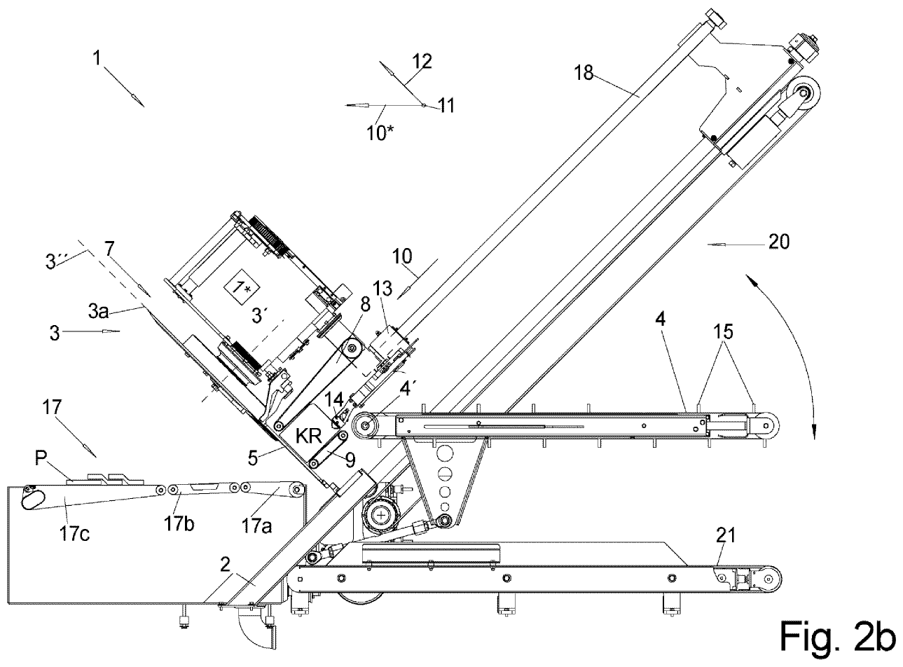

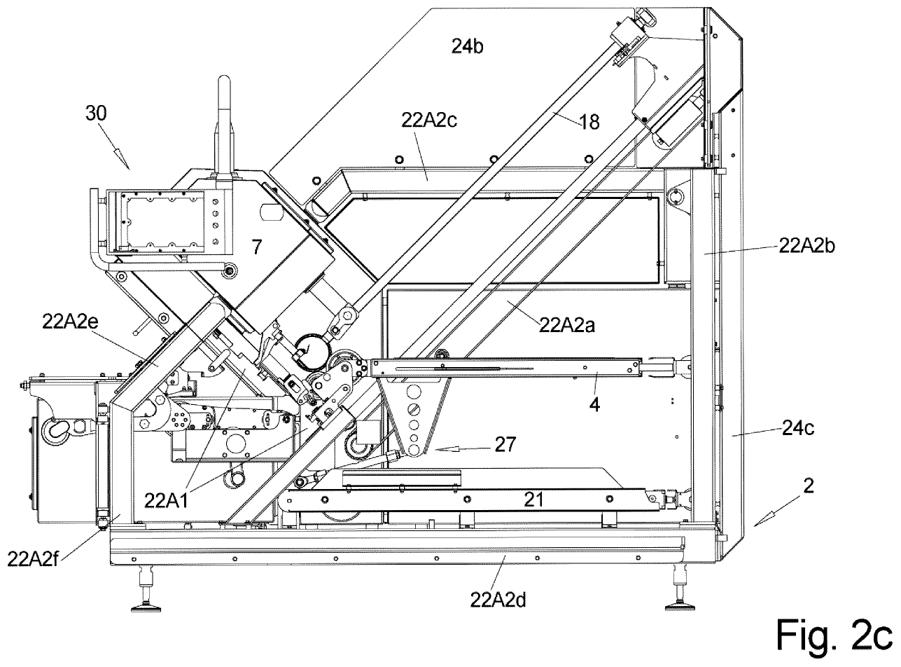

FIG. 2a shows—with the caliber K inserted—a side view of this slicer 1, omitting covers and other parts not relevant to the invention, which are attached to the base frame 2 in the same way as all other units, so that the functional parts, especially the conveyor belts, can be seen more clearly. The longitudinal direction 10 is the supply direction of the calibers K to the slicing unit 7, and thus also the longitudinal direction of the calibers K lying in the slicer 1.

It can be seen that the basic structure of a slicer 1 according to the state of the art is that a cutting unit 7 with blades 3 rotating about a blade axis 3′, such as a sickle blade 3, is provided with several, in this case four, product calibers K lying side by side transversely to the supply direction 10 on a supply conveyor 4 with spacers 15 of the supply conveyor 4 between them on the tracks SP1 to SP4 are fed by this supply unit 20, from the front ends of each of which the rotating blade 3 cuts off a slice S with its cutting edge 3a in one operation, i.e. almost simultaneously.

For slicing the product calibers K, the supply conveyor 4—which can also be equipped with e.g. four individual tracks, one for each product caliber K—is located at the front end of the slicing unit in the sloping cutting position shown in FIGS. 1a-2a, with a low front end on the cutting side and a high rear end on the side, from which it can be folded down about a pivot axis 4′ running in its width direction, the first transverse direction 11, which is located in the vicinity of the cutting unit 7, into an approximately horizontal loading position as shown in FIG. 2b.

The rear end of each caliber K lying in the supply unit 20 is held positively by a gripper 14a-d with the aid of gripper claws 16, as shown in FIG. 2a. These grippers 14a-14d, which can be activated and deactivated with respect to the position of the gripper claws 16, are attached to a common gripper slide 13, which can be moved along a gripper guide 18 in the supply direction 10.

In this case, both the advancing of the gripper slide 13 and of the supply conveyor 4 can be driven in a controlled manner, whereby, however, the actual supply speed of the calibers K is effected by a so-called upper and lower product guide 8, 9, which are also driven in a controlled manner and which engage on the upper side and lower side of the calibers K to be sliced in their front end sections near the cutting unit 7.

The front ends of the calibers K are each guided through a so-called product opening 6a-d of a plate-shaped cutting frame 5, the cutting plane 3″ running immediately in front of the front, obliquely downward-pointing end face of the cutting frame 5, in which cutting plane the blade 3 rotates with its cutting edge 3a and thus cuts off the protrusion of the calibers K from the cutting frame 5 as a slice S. The cutting plane 3″ runs perpendicular to the upper run of the supply conveyor 4 and/or is spanned by the two transverse directions 11, 12 to the supply direction 10.

The inner circumference of the product openings 6a-d serves as a counter-cutting edge of the cutting edge 3a of the blade 3.

Since both product guides 8, 9 can be driven in a controlled manner, in particular independently of each other and/or possibly separately for each track SP1 to SP4, they determine the—continuous or clocked—supply speed of the calibers K through the cutting frame 5.

The upper product guide 8 can be displaced in the second transverse direction 12—which is perpendicular to the surface of the upper run of the supply conveyor 4—for adaptation to the height H of the caliber K in this direction. Furthermore, at least one of the product guides 8, 9 can be designed to pivot about one of its deflecting rollers in order to be able to change the direction of the run of its guide belt lying against the caliber K to a limited extent.

The slices S standing obliquely in space during separation fall onto a discharge unit 17 which begins below the cutting frame 5 and runs in the passage direction 10* and which in this case consists of several discharge conveyors 17a, b, c arranged approximately in alignment with the upper runs of their conveyor belts behind one another in the passage direction 10*, of which the first discharge conveyor 17a in the passage direction 10* can be designed as a portioning belt 17a and/or can also be designed as a weighing belt.

The slices S can hit the portioning belt 17a individually and at a distance from each other in the passage direction 10* or, by appropriate control of the portioning belt 17a of the discharge unit 17—the movement of which, like almost all moving parts, is controlled by the control 1*—form shingled or stacked portions P, by stepwise forward or backward movement of the portioning belt 17a.

The discharge conveyors of the discharge unit 17 can extend across all tracks in the width direction 11 or can each be formed track-individually with several individual discharge conveyors next to each other in the transverse direction 11, i.e. one per track, and can be controlled track-individually.

Below the supply unit 20, there is usually an approximately horizontal end piece conveyor 21, which starts with its front end below the cutting frame 5 and directly below or behind the discharge unit 17 and with its upper run thereon—by means of the drive of one of the discharge conveyors 17 in the opposite direction to the passage direction 10*—transports falling end pieces away to the rear.

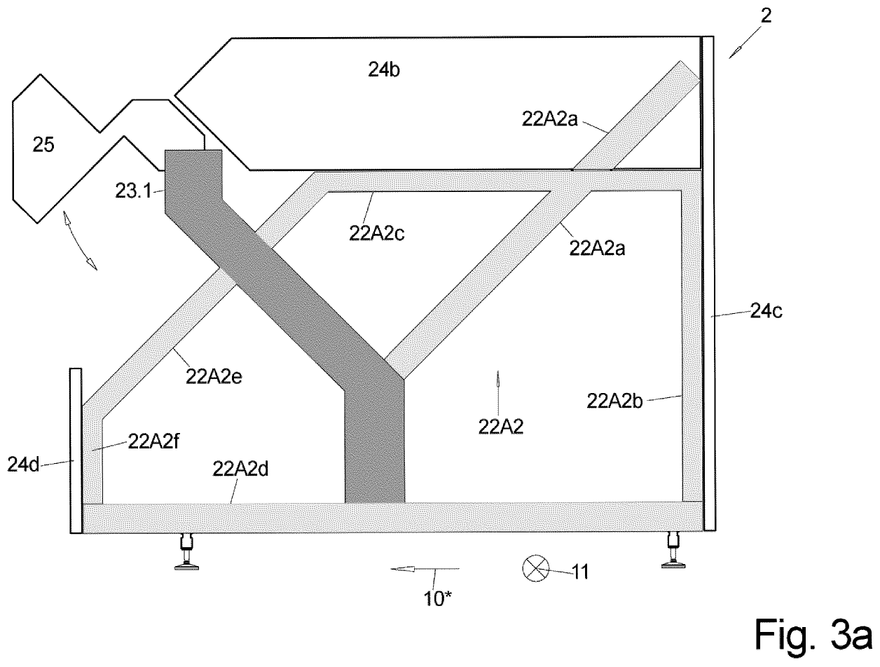

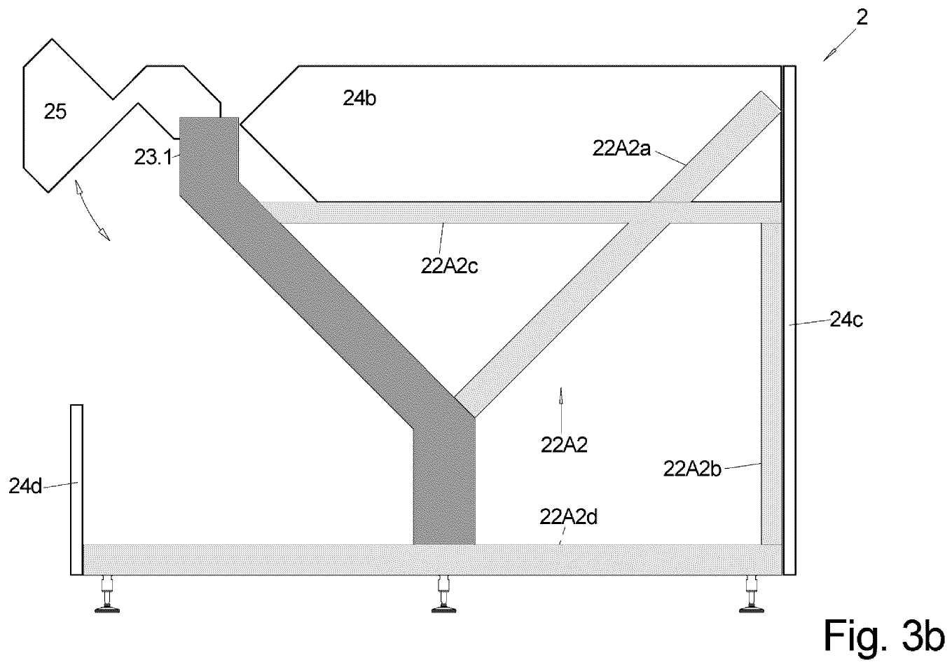

FIG. 2c shows parts of the support frame 2, but many of them are hidden by the functional units, so that the shape and structure of the support frame 2 of the machine of FIG. 2c can be seen better in the side view of the separately shown support frame 2 in FIG. 3a.

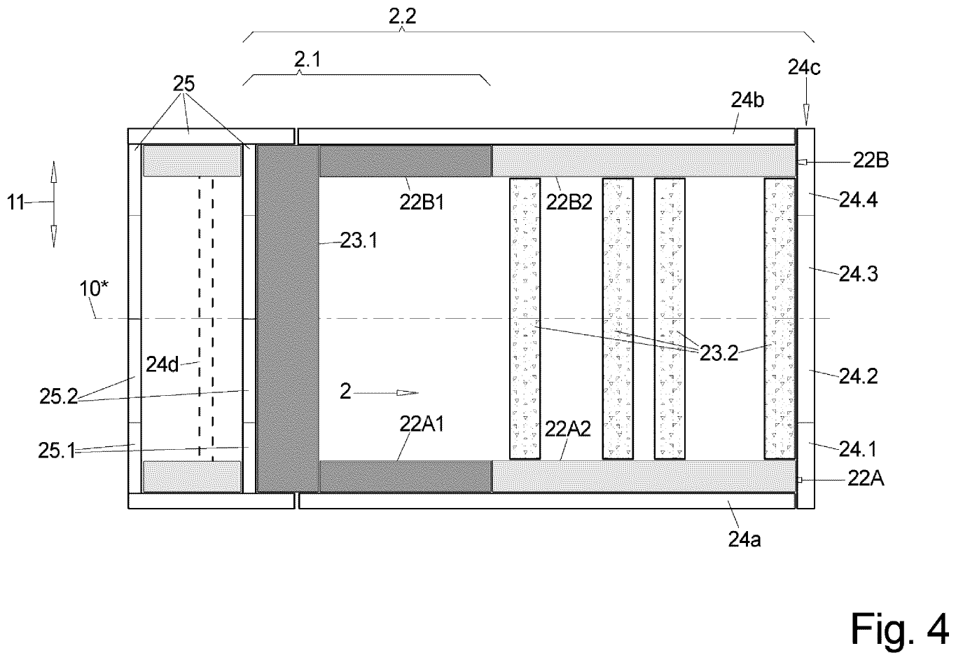

First of all, the top view of FIG. 4 of this support frame 2—which in this FIG. 4, viewed in top view, is completely enclosed by cladding elements 24a, 24b, 24c—shows that this support frame 2 consists of two lateral support modules 22A, 22B which are spaced apart from one another, run parallel to the passage direction 10*, the longitudinal direction, of the machine, and are held at a distance from one another in the transverse direction 11 by transverse support modules 23.1, 23.2 and are fixed against one another.

The lateral support modules 22A, 22B are each subdivided into two lateral support submodules 22A1, 22A2 and 22B1, 22B2, respectively, which are connected to one another by the corresponding transverse support modules 23.1, 23.2 and are kept at a distance from one another in the transverse direction 11.

Thus the lateral support submodules 22A1, 22B1 each consist of—see FIGS. 3a, b—in this case a double-cranked, approximately S-shaped strut, generally in the form of a corresponding steel section, and these two submodules 22A1, 22B1 are directly connected to one another in the transverse direction 11 via only one transverse support module 23.1, namely in their upper end section. The two lateral support submodules 22A1, 22B1 together with this transverse support module 23.1 form the one support frame module 2.1.

A part of the rear lateral support submodule 22B1 can be seen in FIG. 2c, in which only the modules and submodules of the support frame 2 at the rear are shown for reasons of clarity, while those at the front are omitted in order to better identify the functional units.

It is clear from this that the very heavy cutting unit 7, which develops high dynamic forces, is attached to this support frame module 2.1 between its two lateral support submodules 22A1 and 22B1.

The lower ends of the two lateral support submodules 22A1, 22B1 are fastened to one lateral support element 22A2d, which is a longitudinal cross-member of the other lateral support submodule 22A2, 22B2 running horizontally in the passage direction 10*.

It can be seen from FIG. 3a that this side frame submodule 22A2, but also the analogous other 22B2, is an approximately rectangular frame consisting of beam-shaped lateral support elements, the upper left corner of which—in the viewing direction of FIG. 3a, i.e. generally one of the two upper corners—is strongly beveled.

This lateral support element 22A2e forming the bevel, and likewise 22B2e, is firmly connected to the lateral support module 22A1 and 22B1 respectively, whether screwed or welded.

Whether the in-plane lateral support elements 22A2b to 22A2f, for example, are bolted or welded together to form a frame-shaped lateral support submodule 22A2 depends on the stability requirements, but in any case such a frame-shaped, flat lateral support submodule can be stored and provided with very little space requirement.

In the present case, the lateral support submodule 22A2 further comprises a beam-shaped, here straight, lateral support member 22A2a which extends from the lower bend of the lateral support submodule 22A1, where it is attached thereto, at approximately 90° to the leg thereof between the bends, crosses the upper horizontal strut in the form of the lateral support element 22A2c and is also firmly connected to the latter, either bolted or welded, and in the fully assembled machine carries the entire gripper periphery with gripper guide 18, gripper drive, as can be seen in FIG. 2c.

These lateral support submodules 22A2, 22132 are arranged via a number of transverse modules 23.2, which are arranged both between the corresponding, horizontally extending upper and lower, and between the vertically extending lateral support elements of these submodules and are firmly connected to them, in particular detachably, and form the support frame module 2.2.

As FIG. 4 shows, in this case the two support frame modules 2.1, 2.2 extend over different lengths in the passage direction 10*, with the longitudinal section in which the support frame module 2.1 is located lying within the length range over which the support frame module 2.2 extends.

However, the length ranges of the support frame modules 2.1 and 2.2 could also overlap only partially.

FIGS. 2c, 3a and 4 further show that the support frame 2, as viewed in plan, is circumferentially enclosed by cladding elements 24a to 24d, each of which is plate-shaped and upright.

Taking the example of the cladding element 24c, it is shown in FIG. 4 that, viewed from above in the direction of rotation, this can consist of several cladding elements 24.1 to 24.4, again preferably plate-shaped, of which as many as necessary can be placed next to one another in accordance with the length of the transverse support modules 23 or 23.1, 23.2.

The upright cladding element 24b running in the passage direction, which in this case is shown only in the height region above the upper horizontal cross member in the form of the lateral support element 22A2c, could also be present in the height regions below and cover the entire height, which will also be the case in practice.

In addition to the cutting unit 7 as a functional unit, a hood-shaped protection element 25 extending primarily in the transverse direction 11 is also pivotable about a pivot axis extending in the transverse direction 11 and is attached to the front and upper end of the lateral support submodule 22A1, 22B1 in the passage direction.

This protective hood 25 for the blade of the cutting unit 7, which is not shown in FIGS. 1a to 2b or in FIG. 2c for reasons of clarity, completely encloses the blade when folded down and releases it for maintenance and cleaning work when folded up as shown in FIG. 3a.

The plate-shaped cladding element 24b could also be displaceable, in particular in the height direction, along guides—not shown—and thereby form a movable protection element in order to make the lower part of the machine accessible from the side for maintenance work in the raised state as visible in FIG. 3a.

The support frame of FIG. 3b differs from that of the design according to FIG. 3a in that the lateral support submodules 22A2, 22B2—of which only 22A2 is visible in this side view and the other is aligned in the viewing direction behind it 20—is not a circumferentially closed frame, but the lateral support element 22A2c— and also 22B2c—serving as the upper longitudinal cross-member is fastened at its end to one of the double-cranked lateral support modules 22A1 and 22B1, respectively.

Furthermore, no lateral support element projects upward from the downstream end of the lateral support element 22A2d forming the lower longitudinal member, but only the cladding element 24d as in FIG. 3a.

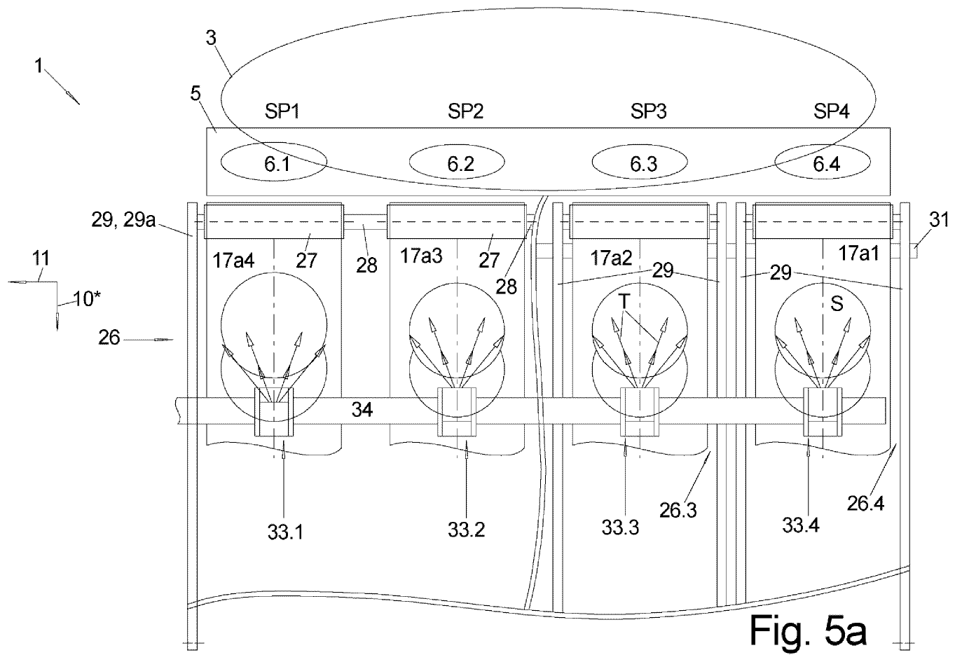

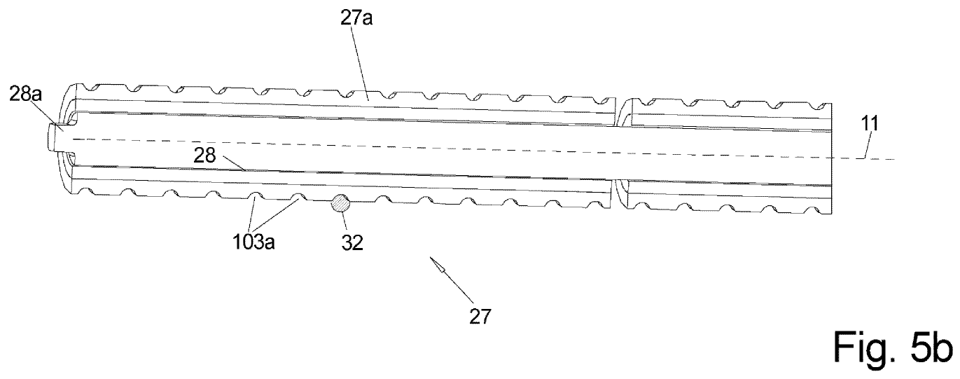

FIG. 5a shows in a top view of the beginning of the discharge conveyor unit 17 of a four-track slicer, as in FIGS. 1a to 2c, the belt units 26 in two different designs as functional parts.

The projections of the calibers not shown, which are projecting through product openings 6.1 to 6.4 and are separated by the blade 3 from the product calibers as slices, fall in each case onto one of the portioning belts 17a1 to 17a4 arranged next to one another in the corresponding distance in the transverse direction, where they are sprayed, for example by means of respective spray units 33.1 to 33.4, with an anticaking agent on their upper side.

The spray units 33.1 to 33.4 are attached to a spray bar 34 extending over all tracks in the transverse direction 11 and are in particular adjustable with regard to the spray direction and the distance to the slice S. The left half of the figure shows a design in which all upstream deflection drums 27 of these portioning belts are mounted on a common axle 28 extending over all tracks, which are each mounted or fixed—depending on the design—with their ends in a side cheek 29a of a base frame 29 for these several portioning belts as a belt unit.

FIG. 5b shows in axial section such a design with a continuous shaft 28, on which several axially spaced deflection drums 27 are arranged, the shell of which can also be of two-layer design in the radial direction, for example because annular grooves 103a are formed in the outer layer for axial, positive fixing of the round belts 32 circulating therein in a belt conveyor.

The right half of FIG. 5a, on the other hand, shows a solution in which each portioning belt 17a1, 17a2 is accommodated in its own base frame 29 and forms an independent conveyor belt unit 26.3, 26.4.

In order to arrange these module-like units side by side in a slicer, a belt unit carrier 31 is preferably used, which extends single or in passage direction multiple times in transverse direction 11 across all tracks, and carries the individual base frames 29 of the individual conveyor belt units, to which they can be attached.

Accordingly, in a construction kit for the manufacture of support frames 2 of different widths, the following functional parts can be used
either base frames 29 of different widths for accommodating a different number of conveyor belt units
and/or different widths of conveyor belts 26.1, 26.2, or a belt unit carrier 31 of different lengths for carrying a different number and/or different widths of belt unit carriers 31
or/and different width of belt units 26.

If the belt units 26 have an axis 28 continuous over the entire width and all tracks, these can also be of different types, namely in particular of different lengths, as construction kit parts.

### LIST OF REFERENCE NUMERALS

1 slicing machine, slicer
1* control
2 support frame
2.1, 2.2 support frame module
3 blades
3 rotation axis
3″ blade plane, cutting plane
3a cutting edge
4 supply conveyor, supply belt
5 cutting frame
6a-d product opening
7 cutting unit
8 upper product guide, upper guide belt
8.1 contact run, lower run
8a cutting side deflecting roller
8b deflecting roller facing away from the cutting side
9 bottom product guide, lower guide belt
8.1 contact run, upper run
9a cutting side deflecting roller
9b deflecting roller facing away from the cutting side
10 machine passage direction, longitudinal direction
10″ vertical longitudinal plane
10* supply direction
11 1^{st} transverse direction (slicer width)
12 vertical
12* 2^{nd} transverse direction (height direction caliber)
13 gripper unit, gripper slide
14,14 a-d gripper
15 spacer
15′ support surface
16 gripper claw
17 discharge conveyor unit
17a, b, c portioning belt, discharge conveyor
18 gripper guide
19 height sensor
20 supply unit
21 end piece conveyor
22A, 22B lateral support module
22A1, 22A2 lateral support submodule
22B1, 22B2 lateral support submodule
22A2a, 22A2b lateral support element
22B1a, 22B1b lateral support element
23.1, 23.2 transverse support module
24a,b cladding elements
24.1, 24.2 cladding elements
25 protection elements
25.1, 25.2 protection elements
26 conveyor belt unit
26.1, 26.2 conveyor belt unit
27 deflection drum
27a jacket
27b ring groove
28 axle
28a bearing journal
29 base frame (for 26)
30 operating unit
31 belt unit carrier
32 round belt
33.1-33.4 spray unit
34 spray bar
K product, product caliber
KR end piece
S slice
P portion

1. A slicing machine for slicing calibers into slices and producing shingled or stacked portions from the slices, comprising:
a support frame with two lateral support modules and at least one transverse support module extending in a transverse direction therebetween,
cladding elements detachably but fixedly attached to the support frame and protection elements detachably but movably attached to the support frame,
functional units detachably attached to the support frame, the functional units comprising:
a cutting unit,
a supply unit for supplying at least one caliber to the cutting unit, and
a discharge unit with at least one portioning belt for conveying away the slices or portions,
wherein
the at least one transverse support module is detachably attached to the lateral support modules,
the lateral support modules each comprise a plurality of lateral support submodules, and
the support frame comprises a plurality of support frame modules that each include one of the plurality of lateral support submodules of each of the lateral support modules.

2. The slicing machine according to claim 1, wherein
the support frame modules have different areas of extension in a longitudinal direction of the slicing machine.

3. The slicing machine according to claim 1, wherein
one of the lateral support submodules comprises a plurality of beam-shaped lateral support elements that are connected to one another, and
the beam-shaped lateral support elements each have a vertical or horizontal main direction of extension.

4. The slicing machine according to claim 3, wherein
the beam-shaped lateral support elements are welded together.

5. The slicing machine according to claim 1, wherein
the lateral support submodules of one of the support frame modules are kept at a distance in the transverse direction by another one of the support frame modules.

6. The slicing machine according to claim 1, wherein
the cladding elements and/or the protection elements extending in the transverse direction comprise cladding elements or protection elements adjoining one another in the transverse direction and detachably connected to one another
and/or
the cladding elements and/or the protection elements extending in a longitudinal direction comprise cladding elements or protection elements adjoining one another in the longitudinal direction and detachably connected to one another.

7. The slicing machine according to claim 1, wherein
the discharge unit comprises functional parts that extend in the transverse direction, and the functional parts comprise conveyor belt units that comprise conveyor belts and/or deflection drums for the conveyor belts and/or axles for the deflection drums, which extend parallel to one another and are detachably connected to one another in the transverse direction.

8. A construction kit for building a slicing machine from construction kit parts of the construction kit, wherein the slicing machine is configured for slicing calibers into slices and producing shingled or stacked portions from the slices, and the slicing machine includes a support frame with two lateral support modules and transverse support modules therebetween, and wherein the construction kit parts comprise:
at least one type of each of the lateral support modules, and
several types of differently dimensioned transverse support modules.

9. The construction kit according to claim 8, wherein
the construction kit parts each have at least one fixing device for releasable connection to another construction kit part.

10. The construction kit according to claim 8, wherein
the lateral support modules each comprise lateral support submodules, and
at least one type each of the lateral support submodules is provided as construction kit parts.

11. The construction kit according to claim 8, wherein the construction kit parts comprise rigid connecting elements and/or movable connecting elements.

12. The construction kit according to claim 8, wherein in case of different types of a construction kit part, the different types
qualitatively have a same overall shape,
but quantitatively the overall shape is provided in different dimensions.

13. The construction kit according to claim 8, wherein in case of different types of a construction kit part, the different types
have qualitatively different overall shapes,
quantitatively, however, the different overall shapes have a same length and/or width.

14. The construction kit according to claim 8, wherein the construction kit parts comprise different types of a slicing machine part having a metal profile, and wherein the different types of the slicing machine part have the metal profile with different wall thickness and/or with different profile cross section.

15. The construction kit according to claim 8, wherein the construction kit parts comprise:
several types of base frames for conveyor belt units
and/or
axles of different lengths for conveyor belt deflection drums.

16. The slicing machine according to claim 1, wherein the lateral support submodules of each lateral support module have overlapping areas of extension in a longitudinal direction.

17. The slicing machine according to claim 1, wherein the at least one transverse support module comprises a first transverse support module connected at a junction of two of the lateral support submodules of one of the lateral support modules.

18. The construction kit according to claim 9, wherein the at least one fixing device of each of the construction kit parts comprises a fixing bore or a fixing flange.

19. A slicing machine for slicing calibers into slices and producing shingled or stacked portions from the slices, the slicing machine comprising:
a support frame with two lateral support modules and at least one transverse support module extending in a transverse direction between the lateral support modules, wherein the at least one transverse support module is detachably attached to the lateral support modules, and the lateral support modules each comprise a plurality of lateral support submodules; and
functional units detachably attached to the support frame, the functional units comprising:
a cutting unit;
a supply unit for supplying at least one caliber to the cutting unit; and
a discharge unit with at least one portioning belt for conveying the slices or portions away from the cutting unit.

20. The slicing machine according to claim 19, further comprising cladding elements detachably but fixedly attached to the support frame, and a protection element detachably but movably attached to the support frame.
